(19) United States
(12) Patent Application Publication
(10) Pub. No.: US 2021/0150926 A1
(43) Pub. Date: May 20, 2021

(54) Method, Apparatus, and Computer Device for Matching Teaching Test Item

(71) Applicants: Qining Jiang, Shenyang, Liaoning (CN); Hanyu Jiang, Tianjin (CN)

(72) Inventors: Qining Jiang, Shenyang, Liaoning (CN); Hanyu Jiang, Tianjin (CN)

(21) Appl. No.: 16/462,161

(22) PCT Filed: Feb. 1, 2019
(86) PCT No.: PCT/CN2019/074489

§ 371 Date: May 17, 2019

(51) Int. Cl. G09B 7/00; G09B 5/00

(52) U.S. Cl. CPC G09B 7/00; G09B 5/00

(57) ABSTRACT

A method, apparatus, and computer device for matching teaching test item are provided, including: acquiring basic information of an object to be tested, to obtain its test category; judging whether a test result of a current teaching test item in the current test category satisfies a set requirement of the current teaching test item, wherein if the test result of the current teaching test item in the current test category fails to satisfy the set requirement, a matched teaching test item matched with the object to be tested is generated for same; acquiring the test result after test is performed using the matched teaching test item, taking the matched teaching test item as a current teaching test item, and executing the step of judging whether a test result of a current teaching test item in the current test category satisfies a set requirement of the current teaching test item.

### TECHNICAL FIELD

The present disclosure relates to the technical field of data processing, particularly to a method, apparatus, computer device, and medium for matching teaching test item.

### BACKGROUND ART

At present, when users receive education by learning courses, various capabilities of the users reflected in behavior, emotion, mentality etc. are evaluated. Generally, the users of different ages are evaluated in a single corresponding dimension, or the user's capabilities are evaluated in multiple dimensions at a single time point. The difficulty lies in that a series of problems, for example, collecting and processing numerous complex evaluation information points, need to be solved when various capabilities of the users reflected in behavior, emotion, mentality etc. are evaluated in multiple dimensions at multiple time points with a unified standard. Currently, modes of evaluating various capabilities of a natural person reflected in behavior, emotion, mentality etc., which produce deviation or are excessively complex by evaluating the capabilities in a single dimension, through contents of a single time of course or in multiple dimensions at a single time point, are hard to be carried out in daily work and life.

When various capabilities of the users are tested with an education system, the users are usually tested with course contents corresponding to various capability levels corresponding to different ages. If a user passes course contents corresponding to age of the user, the user is considered as reaching each corresponding capability level, and if the user fails to pass the course contents corresponding to the age of the user, the user is not considered as reaching each corresponding capability level. At this time, a test result of the user is directly output. However, as the current testing mode determines test results of young children merely through contents of a single time of course, and since the young children may perform differently in different scenes, which may further affect the test results, the test results of young children determined merely through some tests are relatively low in degree of accuracy.

### SUMMARY

In view of this, an object of the present disclosure is to provide a method, apparatus, and computer device for matching teaching test item, which is used to output a teaching test item suitable to an object to be tested, so as to improve the degree of accuracy of an output test result of a teaching test item.

In a first aspect, an embodiment of the present disclosure provides a method for matching teaching test item, wherein the method includes:

acquiring basic information of an object to be tested, to obtain a test category of the object to be tested;

judging whether a test result of a current teaching test item in a current test category satisfies a set requirement of the current teaching test item, wherein if the test result of the current teaching test item in the current test category fails to satisfy the set requirement, a matched teaching test item matched with the object to be tested is generated for the object to be tested;

acquiring the test result after test is performed using the matched teaching test item, taking the matched teaching test item as a current teaching test item, and executing the step of judging whether a test result of a current teaching test item in a current test category satisfies a set requirement of the current teaching test item; and

outputting each generated teaching test item.

In a second aspect, an embodiment of the present disclosure provides an apparatus for matching teaching test item, wherein the apparatus includes:

a first processing module, configured to acquire basic information of an object to be tested, to obtain a test category of the object to be tested;

a second processing module, configured to judge whether a test result of a current teaching test item in the current test category satisfies a set requirement of the current teaching test item, wherein if the test result of the current teaching test item in the current test category fails to satisfy the set requirement, a matched teaching test item matched with the object to be tested is generated for the object to be tested;

a third processing module, configured to acquire the test result after test is performed using the matched teaching test item, and take the matched teaching test item as a current teaching test item, to execute the step of judging whether a test result of a current teaching test item in the current test category satisfies a set requirement of the current teaching test item; and

an output module, configured to output each teaching test item generated by the second processing module.

In a third aspect, an embodiment of the present disclosure provides a computer device, including a storage, a processor, and a computer program stored on the storage and executable on the processor, wherein the processor implements the steps in the above method when executing the computer program.

In the method for matching teaching test item provided in the embodiment of the present disclosure, after the test category of the object to be tested is obtained, it is judged whether the test result of the current teaching test item in the current test category satisfies the set requirement of the current teaching test item, and if the test result of the current teaching test item in the current test category fails to satisfy the set requirement, the matched teaching test item matched with the object to be tested is generated for the object to be tested, the test result after the test is performed using the matched teaching test item is acquired, the matched teaching test item is taken as the current teaching test item, and the step of judging whether the test result of the current teaching test item in the current test category satisfies the set requirement of the current teaching test item is executed. In this way, when the object to be tested fails to satisfy the set requirement of the teaching test item in the current test category, a teaching test item suitable to the object to be tested is further matched for the object to be tested, such that an output teaching test item is more suitable to the object to be tested, and further, a test result after the object to be tested is tested with the teaching test item is more accurate.

In order to make the above objects, features, and advantages of the present disclosure more apparent and understandable, preferred embodiments are particularly illustrated below in combination with attached accompanying drawings to make detailed description as follows.

### BRIEF DESCRIPTION OF DRAWINGS

In order to more clearly illustrate technical solutions of embodiments of the present disclosure, accompanying drawings which are needed to be used in the embodiments will be introduced briefly below. It should be understood that the accompanying drawings below merely show some embodiments of the present disclosure, and therefore should not be considered as a limitation on the scope. A person ordinarily skilled in the art still can obtain other relevant accompanying drawings according to these accompanying drawings, without inventive efforts.

FIG. 1 is a flowchart of a method for matching teaching test item provided in an embodiment of the present disclosure;

FIG. 2 is a first structural schematic diagram of an apparatus for matching teaching test item provided in an embodiment of the present disclosure;

FIG. 3 is a second structural schematic diagram of the apparatus for matching teaching test item provided in the embodiment of the present disclosure; and

FIG. 4 is a structural schematic diagram of a computer device provided in an embodiment of the present disclosure.

### DETAILED DESCRIPTION OF EMBODIMENTS

In order to make objects, technical solutions, and advantages of the embodiments of the present disclosure clearer, the technical solutions in the embodiments of the present disclosure will be described clearly and completely below in conjunction with accompanying drawings in the embodiments of the present disclosure. Apparently, some but not all embodiments of the present disclosure are described. Generally, components in the embodiments of the present disclosure, as described and shown in the accompanying drawings herein, may be arranged and designed in various different configurations. Therefore, the detailed description below of the embodiments of the present disclosure provided in the accompanying drawings is not intended to limit the scope of the present disclosure claimed, but merely illustrates chosen embodiments of the present disclosure. All other embodiments obtained by a person skilled in the art based on the embodiments of the present disclosure without inventive efforts shall fall within the scope of protection of the present disclosure.

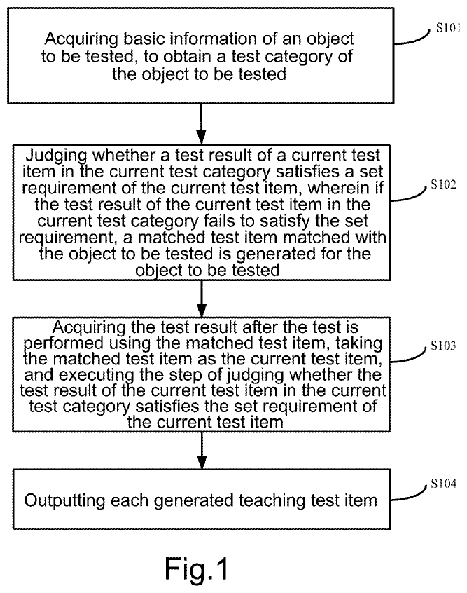

An embodiment of the present disclosure provides a method for matching teaching test item. As shown in FIG. 1, the method for matching teaching test item is applied to a matching system of teaching test item. The matching system of teaching test item includes a terminal device, for example, a computer, a notebook computer, a tablet computer, a mobile phone, a portable device, a vehicle-mounted device and so on, and also includes a network system, for example, an audio-visual service system, a large-screen system, a client/server system (C/S), a browser/server system, a cloud computing system and so on. Type and architecture of the matching system of teaching test item are not limited herein. The method includes:

S101, acquiring basic information of an object to be tested, to obtain a test category of the object to be tested;

wherein the object to be tested may be users in different age groups. The age groups may be, for example, 4-month-old children, 5-month-old children, 6-month-old children, 1-year-old children, 2-year-old children, 2-year-and-1-month-old children, 2-year-and-2-month-old children, 3-year-old children, 4-year-old children and so on; the basic information includes, but is not limited to, full name, age, sex, race, region, nationality, blood type, biological information, activity scene, number of activity people, personality and so on, wherein the region can be determined according to residential information of the object to be tested, the biological information may be genetic testing information of the user and so on, which is not limited in the present disclosure; the test category includes, but is not limited to, education category, sanitation category, medical science category and so on, wherein the education category includes, but is not limited to, health, language, sociology, science, arts and so on, the sanitation category includes, but is not limited to, gross motor, fine motor, language, adaptive capability, social activity and so on, and the medical science category includes, but is not limited to, personality, temperament, social, emotion, exercise, cognition, language, sensory perception, intelligence and so on, which can be determined according to practical situations, and are not limited in the present disclosure.

In specific implementation, after the basic information of the user is obtained, although multiple pieces of information of the object to be tested are acquired, for example, full name, age, body weight, sex, race, region and so on, not all basic information can be used for the user to determine the test category corresponding to the user, therefore, information matched with information in a test category determination table is extracted from the acquired basic information, and a test category corresponding to the basic information matched with the extracted information is inquired from the test category determination table. If the test category corresponding to the basic information matched with the extracted information is found, the found test category is taken as the test category of the user to be tested. In the above, the test category determination table includes correspondence relationships between the basic information and test categories, preferably determined according to age, sex, region, nationality, place of class, and class size of the object to be tested.

S102, judging whether a test result of a current teaching test item in the current test category satisfies a set requirement of the current teaching test item, wherein if the test result of the current teaching test item in the current test category fails to satisfy the set requirement, a matched teaching test item matched with the object to be tested is generated for the object to be tested.

Herein, each test category includes level 1 test category, level 2 test category, and level 3 test category, wherein a lower level test category is subdivision of an upper level test category; each test category contains multiple teaching test items, different teaching test items are of different levels, the test result can be represented by a test score, and the set requirement may be a score range corresponding to the current teaching test item. When the test result of the current teaching test item falls within or goes beyond the corresponding score range, the test result of the current teaching test item satisfies the set requirement, and when the test result of the current teaching test item is lower than a minimum value of the score range, the test result of the current teaching test item fails to satisfy the set requirement. In the above, the score range can be determined according to practical situations, and the teaching test items generally are test items in the education field, for example, the teaching test items are test subjects and so on in the education field.

When the matched teaching test item matched with the object to be tested is generated for the object to be tested, following steps are included:

selecting, from a preset teaching test item determination table, a teaching test item being of a level lower than that of the current teaching test item and satisfying a test scene requirement corresponding to the current test category of the object to be tested, and taking the selected teaching test item as the matched teaching test item.

When the test is performed for each test category, the step of selecting a teaching test item being of a level lower than that of the current teaching test item and satisfying a test scene requirement corresponding to the current test category of the object to be tested, and taking the selected teaching test item as the matched teaching test item further includes:

judging whether the number of the teaching test items each failing to satisfy respective set requirement is greater than a set threshold value;

wherein if the number of the teaching test items each failing to satisfy respective set requirement is greater than the set threshold value, a teaching test item being of a level lower than that of the current teaching test item and satisfying the test scene requirement corresponding to the current test category of the object to be tested is selected from the preset teaching test item determination table, and the selected teaching test item is taken as the matched teaching test item. In this way, the teaching test item suitable to the object to be tested can be output in a targeted manner, thus forming a system capable of performing continuous evaluation in a multidimensional and dynamic manner with a unified standard.

Since there are small differences among age groups, and tested objects in different age groups have capabilities in different directions, different teaching test items are output for different ages, thus achieving multiple systems in ages. For example, for a teaching test item for 3-year-and-1-month-old children, a test result can be evaluated with a standard for 3-year-and-1-month-old children, and also can be evaluated with standards for children of adjacent month ages, thus obtaining a result synthetically; in terms of capability category, an instant result can be obtained for some capabilities, for example, capabilities in aspects of action and language, and such results can be obtained instantly, and results also can be obtained in a continuous manner to be more accurate, when personality, temperament or other aspects are tested, long-term continuous measurement is certainly needed, and they are evaluated with various standard systems to synthetically reflect state of a tested object.

Herein, apart from object relationships between the teaching test item levels and the teaching test items, the teaching test item determination table further includes correspondence relationships among the basic information, the test scenes, and the test categories. Since different ages have different characteristics, different ages may be corresponding to different teaching test item levels in the teaching test item determination table; the set threshold value may be a product of a total number of the teaching test items included in the test category and a set proportion, wherein the set proportion may be 0.5, 0.6, 0.7, 0.8 and so on, which can be determined according to practical situations, and is not limited in the present disclosure.

In specific implementation, it is judged whether the number of the teaching test items each failing to satisfy respective set requirement is greater than the set threshold value. If the number of the teaching test items each satisfying respective set requirement is smaller than or equal to the set threshold value, it is determined that the test result of the current teaching test item in the current test category satisfies the set requirement, and if the number of the teaching test items each failing to satisfy respective set requirement is greater than the set threshold value, the test result of the current teaching test item in the current test category fails to satisfy the set requirement, and further, teaching test items being of a level lower than that of the current teaching test item are selected from the teaching test item determination table. After the teaching test items being of a level lower than that of the current teaching test item are selected, further, the test scene corresponding to the current test category is acquired, and according to the test scene corresponding to the current test category, a teaching test item satisfying the test scene requirement of the current test category is selected from the teaching test items selected from the teaching test item determination table. In the above, the test scene may be a test scene, the number of tested people, and so on.

For example, for action-gross motor-movement included in a teaching test item, a corresponding teaching test element is: letting a child walk five meters along a drawn straight line in three seconds. If a test result is two meters, the test result of this teaching test item fails to satisfy the set requirement, then the teaching test item will be adjusted in next time of test, for example, letting the child move five meters, rather than walking five meters along a straight line.

For another example, for social-communication with people-communication skill included in a teaching test item, a corresponding teaching test element is: letting a child say Hello and Goodbye to a stranger. If a test result is that the child fails to say Hello and has no Goodbye expression, results for this teaching test item can be collected several times, and contents of the course may be adjusted to let the child express skills of communicating with people, and let the child say Hello and Goodbye to other children or acquaintances.

For another example, for personality-hyperaction-unconscious shaking included in a teaching test item, a corresponding teaching test element is behavior of a child waiting in line. If a test result is that the child cannot wait quietly, but moves around or sways, for the test of personality, only a state is recorded, and personality characteristics and state of the child are identified after long-term continuous recording.

S103, acquiring the test result after the test is performed using the matched teaching test item, taking the matched teaching test item as the current teaching test item, and executing the step of judging whether the test result of the current teaching test item in the current test category satisfies the set requirement of the current teaching test item.

If the test result of the current teaching test item in the current test category satisfies the set requirement of the current teaching test item, tests are performed for teaching test items in a next test category, until tests for all of the test categories are completed.

If each test result corresponding to each of the teaching test items in each of the current test categories satisfies the set requirement, teaching test items being of a level higher than that of each of the current test categories and satisfying a test scene requirement corresponding to each next test category of the object to be tested are selected from the preset teaching test item determination table.

S104, outputting each generated teaching test item.

Herein, the teaching test item generated each time can be output to a terminal device on a user side, such that it is convenient to test the object to be tested with a received teaching test item on the user side.

In specific implementation, the teaching test items corresponding to the current test category are acquired, and the object to be tested is tested using the acquired teaching test items. In testing, an executing order of the teaching test items may be random, and also may be determined according to priorities of the teaching test items, which is not limited in the present disclosure.

With changes of age, the standard also changes, and the state of the object to be tested also changes in, e.g. personality, temperament and so on. In order to improve the degree of accuracy of the test items output, before the teaching test items are matched with the object to be tested, the teaching test items are usually adjusted according to the test results of personality, temperament and so on, aiming at improving a matching degree between the output teaching test items and the object to be tested. Technologies for testing personality of the object to be tested have been introduced in detail in the prior art, and will not be described herein.

In specific implementation, a first teaching test item is acquired according to an order of the teaching test items to test the object to be tested, the first teaching test item is taken as the current teaching test item, to judge whether a test result of the current teaching test item satisfies a set requirement of the current teaching test item. If the test result of the current teaching test item satisfies the set requirement, a next teaching test item is acquired, and the next teaching test item is taken as a current teaching test item, to execute the step of judging whether a test result of the current teaching test item satisfies a set requirement of the current teaching test item; if the test result of the current teaching test item fails to satisfy the set requirement, it is judged whether the number of teaching test items each failing to satisfy respective set requirement is greater than a set threshold value, wherein if the number of the teaching test items each failing to satisfy respective set requirement is not greater than the set threshold value, it continues to acquire and execute a next teaching test item, and the next teaching test item is taken as a current teaching test item, to execute the step of judging whether a test result of the current teaching test item satisfies the set requirement of the current teaching test item.

In a process of judging the current test category, if the number of the teaching test items each failing to satisfy respective set requirement is greater than or equal to the set threshold value, the teaching test item being of a level lower than that of the current teaching test item and satisfying the test scene requirement corresponding to the current test category is selected from the preset teaching test item determination table, the selected teaching test item is taken as the matched teaching test item, and the matched teaching test item is taken as the current teaching test item, to execute the step of judging whether the test result of the current teaching test item in the current test category satisfies the set requirement of the current teaching test item.

In the process of judging the current test category, if the number of the teaching test items each failing to satisfy respective set requirement is smaller than the set threshold value, the test for the current test category is completed, and the test is performed for teaching test items in next test category, until tests for all test categories are completed.

If each test result corresponding to each of the teaching test items in all of the test categories satisfies the set requirement, for each test category in all of the test categories, a test category being of a level higher than that of this test category is selected from the preset teaching test item determination table, the test scene corresponding to the selected test category is acquired, and further the teaching test item satisfying the test scene requirement corresponding to the acquired test category is determined.

When the object to be tested is tested, a test form may be realized by means of a two-dimensional device, a three-dimensional device, a wearable device, a player and so on, wherein the wearable device may be a VR device or the like, the test form can be selected according to the test scenes, and is not limited in the present disclosure.

The teaching test item determination table is constructed in a following manner:

acquiring historical data;

determining, from the historical data, multiple test categories and at least one keyword corresponding to each test category;

determining a teaching test item corresponding to each of the keywords; and

generating the teaching test item determination table including correspondence relationships between the test category levels and the teaching test items corresponding to the test categories.

The teaching test item determination table further includes a test capability determination table, which is constructed in a following manner:

determining at least one corresponding test category level for each test category; and

forming the test capability level determination table including correspondence relationships between the test category levels and the test categories.

Herein, the historical data includes clinical guidelines, test questionnaires, test scales, medical literatures and so on, wherein the test questionnaires include age of the tested object and the teaching test items; the keywords are used to express item classifications, such as tall or short, fat or thin, morning or afternoon, running, saying Hello and so on; extracting manners have been introduced in detail in the prior art, and will not be described redundantly herein.

The test categories include gross motor, social, sanitation and so on; the test category levels are used to evaluate the test results of corresponding test categories, and different test categories are corresponding to different test category levels.

In specific implementation, the test categories are extracted from the clinical guidelines and the medical literatures, and further at least one keyword corresponding to each test category is extracted from the test questionnaires, correspondence relationships between the obtained keywords and the test categories are as follows:

| Test | Level 1 Test | Level 2 Test | Level 3 Test | |
|---|---|---|---|---|
| Category | Category | Category | Category | Keyword |
| Sanitation | gross motor | gross motor | gross motor | head upright A-2s |
| Sanitation | gross motor | gross motor | gross motor | head upright B-5s |
| Medical | social | social skill | interaction with | stranger A-simple |
| Science | | | stranger | conversation |
| Medical | social | social skill | interaction with | stranger C-continue |
| Science | | | stranger | a topic |
| Medical | language | language | adjective | adjective A-long |
| Science | | expression | expression | or short |
| Medical | language | language | adjective | adjective B-tall |
| Science | | expression | expression | or short |
| Medical | exercise | fine motor | grasp | hold a pen A |
| Science | | | | |
| Medical | exercise | gross motor | move | run A-9 meters |
| Science | | | | |

The teaching test items corresponding to each keyword are extracted from the test questionnaires, and the test category level is determined for each test category according to the clinical guidelines, wherein the test category levels may be represented by test result ranges, different test category levels belong to different test result ranges, the test category levels corresponding to different test categories are all recorded in related literatures in the clinical guidelines. After the test categories are determined, the test category level corresponding to the current test category is determined respectively for each test category, further, the teaching test item determination table is formed according to the determined test category levels and the teaching test items, to obtain the teaching test item determination table (the teaching test items, which are not reflected in the teaching test item table, are specified below):

| Test | Level 1 Test | Level 2 Test | Level 3 Test | | Test Level |
|---|---|---|---|---|---|
| Category | Category | Category | Category | Keyword | Classification |
| Sanitation | gross motor | gross motor | gross motor | head upright A-2s | 3 |
| Sanitation | gross motor | gross motor | gross motor | head upright B-5s | 3 |
| Medical | social | social skill | interaction | stranger A-simple | 3 |
| Science | | | with stranger | conversation | |
| Medical | social | social skill | interaction | stranger C-continue | 3 |
| Science | | | with stranger | a topic | |
| Medical | language | language | adjective | adjective A-long or | 3 |
| Science | | expression | expression | short | |
| Medical | language | language | adjective | adjective B-tall or | 3 |
| Science | | expression | expression | short | |
| Medical | exercise | fine motor | grasp | hold a pen A | 3 |
| Science | | | | | |
| Medical | exercise | gross motor | move | run A-9 meters | 3 |
| Science | | | | | |

Apart from the correspondence relationships between the test category levels and the teaching test items and the test capability level determination table, the teaching test item determination table further includes a teaching test element table.

The teaching test element table is constructed in a following manner:

extracting basic information corresponding to the teaching test items from the historical data;

determining at least one corresponding teaching test element for each teaching test item; and

forming the teaching test element table including correspondence relationships among the basic information, the teaching test items, and the teaching test elements.

Herein, the teaching test element is a minimum test unit or test step in a teaching test item, and the teaching test elements are used to test users' behaviors.

The teaching test elements corresponding to different test scenes are introduced below, with reference to the following table.

| | | | Proportion of | Relationship | |
|---|---|---|---|---|---|
| | Number | | Learner to | between Learner | |
| Test Scene | of People | Teacher | Teacher | and Teacher | Front-end Problem |
| Teaching in School | >10 | >2 | >=5 | teacher and student | Can the child speak |
| | | | | | clearly? Can a stranger |
| | | | | | get half of the child's |
| | | | | | words? |
| Parent-child | <2 | <=2 | <5 | family/guardian | Does the child like gazing |
| | | | | | for a long time? (for |
| | | | | | example, gazing at a |
| | | | | | space/a person/an |
| | | | | | article/his/her own |
| | | | | | hand/finger/light |
| | | | | | ray/flickering light?) |
| Parent-child | <2 | <=2 | <5 | family/guardian | Does the child always |
| | | | | | observe an article out of |
| | | | | | the corner of her/his |
| | | | | | eyes? |
| Teaching in School | >10 | >2 | >=5 | teacher and student | Whether the child is |
| | | | | | absent-minded and easily |
| | | | | | distracted |
| Teaching in School/ | unlimited | unlimited | unlimited | unlimited | Whether the child is |
| Parent-child/ | | | | | absent-minded and easily |
| Special Subject | | | | | distracted |
| Teaching in School | >10 | >2 | >=5 | teacher and student | Is the child in constant |
| | | | | | motion without break? |
| Teaching in School | >10 | >2 | >=5 | teacher and student | Whether the child is |
| | | | | | absent-minded and easily |
| | | | | | distracted |
| Teaching in | unlimited | unlimited | unlimited | unlimited | Does the child know three |
| School/Parent-child/ | | | | | colors? Let the child tell |
| Special Subject | | | | | the colors he/she knows. |

In specific implementation, after the basic information corresponding to the teaching test item is obtained, based on test requirements, at least one teaching test element or teaching test step is determined for each teaching test item from the questionnaires in the historical data, and the teaching test element table including the correspondence relationships among the basic information, the teaching test items, and the teaching test elements is formed based on each teaching test item and corresponding basic information and teaching test elements. In the above, the test requirements may be put forward according to the test scene, and also may be put forward according to the test category, which is not limited in the present disclosure.

For example, plenty of teaching test items A for testing basic information T1, plenty of teaching test items B for testing basic information T2, and plenty of teaching test items C for testing basic information T3 are acquired from the historical data. According to the test scene, the teaching test elements determined for teaching test items A include A11, A12, and A13, the teaching test elements determined for teaching test items B include B11 and B12, the teaching test elements determined for teaching test items C include C11, C12, and C13, and the teaching test element table among the basic information (T1, T2, T3), the teaching test items (A, B, C), and the teaching test elements (A11, A12, A13, B11, B12, C11, C12, C13) is generated.

The teaching test items are described below:

Since many test categories are involved in the present disclosure, the description is made merely for the gross motor. The gross motor may be corresponding to multiple teaching test items, with each teaching test item including multiple teaching test elements. A teaching test item including five teaching test elements is described as an example:

After sitting up with shoulders being lifted, can the child sit up for 2 seconds with head upright?

After sitting up with wrists being pulled, can the child sit up for 5 seconds with head upright?

After the head is put right, can the child keep the head straightened for 10 seconds?

When lying on his/her belly, whether the child raises his/her head or not?

When lying on his/her belly, can the child raise his/her head and keep his/her head raised for 2 seconds?

The teaching test elements can also refer to the following examples:

Parents can draw a straight line on a sheet of paper, and let the child cut to observe whether the child can cut with scissors along the straight line;

Parents give the child a piece of colored paper, and let the child fold it in half to observe the child's capability of folding along edges;

Parents can draw simple shapes formed by straight lines on a sheet of paper and let the child cut to observe whether the child can cut with scissors along the straight lines;

Parents observe the child's situation of using scissors;

Parents can draw simple shapes formed by curves on a sheet of paper and let the child cut to observe whether the child can cut with scissors along the curves.

However, it should be noted that the above teaching test elements are merely schematic, and no limitation is made thereto in the present disclosure.

The above examples are merely schematic, and each of the test categories is not described one by one in the present disclosure, but can be determined according to practical situations in practical application.

When a course item determination table is constructed, course items in different environments may be set for different places of class and different class sizes. The places of class may be home (generally with a class size of 2 persons), outdoors (possibly with a class size of many persons), or school (generally with a class size of 10-20 persons). Therefore, when the course item is set, if the place of class is home, parent-child class is correspondingly set, if the place of class is school, teaching-in-school class is correspondingly set, and if the place of class is outdoors, extracurricular class may be correspondingly set. The course items in different test scenes are set for each test category according to different places of class. Meanwhile, for each test scene, a test objective of this test scene is set, for example, when the test scene is the teaching-in-school class, the test objective is universal screening. Test objectives of other test scenes are similar to this, and are not introduced redundantly herein.

For example, it is acquired that object to be tested is 3 years old, female, of yellow race, and Mongol nationality, the place of class is kindergarten, and the class size is of 10 persons, then the teaching-in-school class is set for the object to be tested. When the object to be tested is tested through the teaching test item, it can be realized by a three-dimensional device in a teacher's hand. The three-dimensional device shows pictures, and correspondingly plays sounds, “Who is on the picture?”, “This is bird kindergarten, this is white rabbit kindergarten, and this is sika deer kindergarten” and so on. The teacher determines a score of each teaching test item according to replies of object to be tested. If a current score falls within a score range corresponding to the current teaching test item level, it is determined that the object to be tested achieves the level of the current teaching test item, and if the current score fails to reach the score range corresponding to the current test level, it is determined that the object to be tested fails to achieve the level of the current teaching test item.

It is difficult to determine whether the object to be tested achieves a required level of the current test category merely through one teaching test item, therefore, when the current teaching test item fails to satisfy the set requirement, the object to be tested continues to be tested with other teaching test items in the current test level, and only after the number of the teaching test items having completed by the object to be tested and failing to satisfy the set requirement reaches a set threshold value, it is determined at this time that the object to be tested fails to reach the level required by the current test category, at which time, a teaching test item with a lower teaching test item level is selected to test the object to be tested. A process of testing the object to be tested with the teaching test item being of a lower level is similar to the above example, and is not described in detail herein.

If the object to be tested satisfies the requirement of the teaching test item being of a lower level, the tested object can continue to be tested with a teaching test item matched with the age of the object to be tested, and if the tested object still fails to satisfy the requirement in the test again, the test of the current test category is ended.

Other test categories determined for the object to be tested are tested. Processes of testing other test categories are similar to the above process, and are not described one by one herein.

After all test categories for the object to be tested are ended, a test result is generated for object to be tested. The test result includes the test categories in which the object to be tested satisfies requirements and the test categories in which the object to be tested fails to satisfy requirements, and recommendations are offered to guardians of the object to be tested, suggesting that the guardians train the capabilities of the object to be tested in a targeted manner.

In the present disclosure, after the test category of the object to be tested is obtained, it is judged whether the test result of the current teaching test item in the current test category satisfies set requirement of the current teaching test item. If the test result of the current teaching test item in the current test category fails to satisfy the set requirement, a matched teaching test item matched with the object to be tested is generated for the object to be tested, a test result after the test is carried out using the matched teaching test item is acquired, and the matched teaching test item is taken as the current teaching test item, to execute the step of judging whether the test result of the current teaching test item in the current test category satisfies the set requirement of the current teaching test item. In this way, when the object to be tested fails to satisfy the set requirement of the teaching test item in the current test category, a teaching test item suitable to the object to be tested is further matched for the object to be tested, such that an output teaching test item is more suitable to the object to be tested, and further, a test result after the object to be tested is tested with the teaching test item is more accurate.

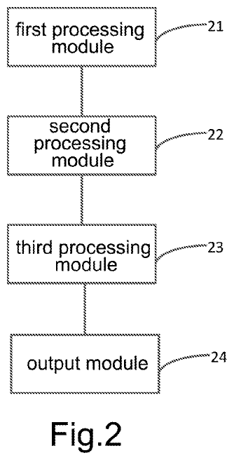

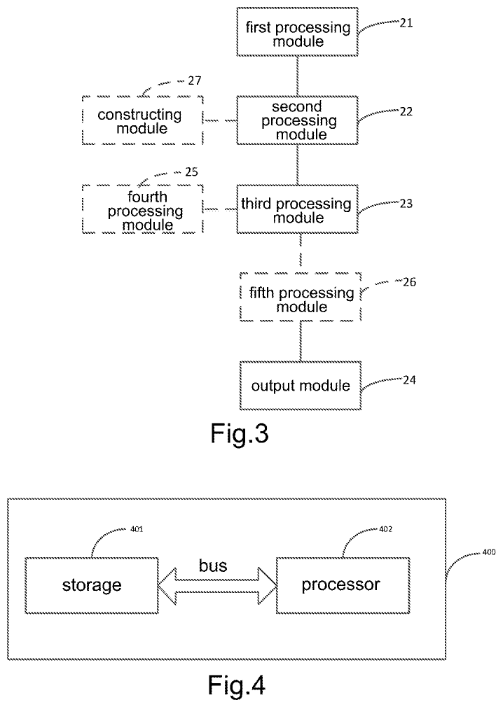

An embodiment of the present disclosure provides an apparatus for matching teaching test item. As shown in FIG. 2, the apparatus includes:

a first processing module 21, configured to acquire basic information of an object to be tested, to obtain a test category of the object to be tested;

a second processing module 22, configured to judge whether a test result of a current teaching test item in the current test category satisfies a set requirement of the current teaching test item, wherein if the test result of the current teaching test item in the current test category fails to satisfy the set requirement, a matched teaching test item matched with the object to be tested is generated for the object to be tested;

a third processing module 23, configured to acquire the test result after the test is performed using the matched teaching test item, and take the matched teaching test item as a current teaching test item, to execute the step of judging whether a test result of the current teaching test item in the current test category satisfies a set requirement of the current teaching test item; and

an output module 24, configured to output each teaching test item generated by the second processing module.

Optionally, a fourth processing module 25 is further included, and the fourth processing module is specifically configured to:

perform a test for a teaching test item in a next test category, if the test result of the current teaching test item in the current test category satisfies the set requirement of the current teaching test item, until tests for all of the test categories are completed.

Optionally, the second processing module 22 is specifically configured to:

select a teaching test item being of a level lower than that of the current teaching test item and satisfying a test scene requirement corresponding to the current test category of the object to be tested from a preset teaching test item determination table, and take the selected teaching test item as the matched teaching test item.

Optionally, the third processing module 23 is further configured to:

judge whether the number of the teaching test items each failing to satisfy respective set requirement is greater than a set threshold value;

wherein if the number of the teaching test items each failing to satisfy respective set requirement is greater than the set threshold value, the teaching test item being of a level lower than that of the current teaching test item and satisfying a test scene requirement corresponding to the current test category of the object to be tested is selected from the preset teaching test item determination table, and the selected teaching test item is taken as the matched teaching test item.

Optionally, a fifth processing module 26 is further included, and the fifth processing module 26 is configured to:

select a teaching test item being of a level higher than the test category level and satisfying a test scene requirement corresponding to each next test category of the object to be tested for each test category in all of the test categories from the preset teaching test item determination table, if each test result corresponding to each of the teaching test items in all of the test categories satisfies the set requirement.

Optionally, a constructing module 27 is further included, and the constructing module constructs the teaching test item determination table in a following manner:

acquiring historical data;

determining, from the historical data, multiple test categories and at least one keyword corresponding to each test category;

determining a teaching test item corresponding to each of the keywords; and

generating the teaching test item determination table including correspondence relationships between the test category levels and the teaching test items corresponding to the test categories.

Optionally, the teaching test item determination table at least includes a teaching test element table, and the constructing module 27 constructs the teaching test element table in a following manner:

extracting basic information corresponding to the teaching test items from the historical data;

determining at least one corresponding teaching test element for each teaching test item; and

forming the teaching test element table including correspondence relationships among the basic information, the teaching test items, and the teaching test elements.

Optionally, the teaching test item determination table at least includes a test capability level determination table, and the constructing module 27 constructs the test capability determination table in a following manner:

determining at least one corresponding test category level for each test category; and

forming the test capability level determination table including correspondence relationships between the test categories and the test category levels.

Optionally, the basic information at least includes sex, age, region, race, nationality, blood type, activity scene, and personality.

Corresponding to the method for matching teaching test item in FIG. 1, an embodiment of the present disclosure further provides a computer device 400. As shown in FIG. 4, the device includes a storage 401, a processor 402, and a computer program stored on the storage 401 and executable on the processor 402, wherein the above processor 402 achieves the above method for matching teaching test item when executing the above computer program.

Specifically, the above storage 401 can be a general-purpose storage and the above processor 402 can be a general-purpose processor, which are not specifically defined herein. When the processor 402 executes the computer program stored on the storage 401, the above method for matching teaching test item can be executed, for outputting the teaching test item suitable to the object to be tested, so as to improve the degree of accuracy of the test result. In the present disclosure, after the test category of the object to be tested is obtained, it is judged whether the test result of the current teaching test item in the current test category satisfies the set requirement of the current teaching test item. If the test result of the current teaching test item in the current test category fails to satisfy the set requirement, a matched teaching test item matched with the object to be tested is generated for the object to be tested, a test result after the test is carried out using the matched teaching test item is acquired, and the matched teaching test item is taken as the current teaching test item to execute the step of judging whether the test result of the current teaching test item in the current test category satisfies the set requirement of the current teaching test item. In this way, when the object to be tested fails to satisfy the set requirement of the teaching test item in the current test category, a teaching test item suitable to the object to be tested is further matched for the object to be tested, such that an output teaching test item is more suitable to the object to be tested, and further, a test result after the object to be tested is tested with the teaching test item is more accurate.

Corresponding to the method for matching teaching test item in FIG. 1, an embodiment of the present disclosure further provides a computer-readable storage medium, on which a computer program is stored. Steps in the above method for matching teaching test item are executed when the computer program is executed by the processor.

Specifically, the storage medium can be a general-purpose storage medium, for example, removable disk, and hard disk. When the computer program on the storage medium is executed, the above method for matching teaching test item can be executed, for outputting the teaching test item suitable to the object to be tested, so as to improve the degree of accuracy of the test result. In the present disclosure, after the test category of the object to be tested is obtained, it is judged whether the test result of the current teaching test item in the current test category satisfies the set requirement of the current teaching test item. If the test result of the current teaching test item in the current test category fails to satisfy the set requirement, a matched teaching test item matched with the object to be tested is generated for the object to be tested, a test result after the test is carried out using the matched teaching test item is acquired, and the matched teaching test item is taken as the current teaching test item to execute the step of judging whether the test result of the current teaching test item in the current test category satisfies the set requirement of the current teaching test item. In this way, when the object to be tested fails to satisfy the set requirement of the teaching test item in the current test category, a teaching test item suitable to the object to be tested is further matched for the object to be tested, such that an output teaching test item is more suitable to the object to be tested, and further, a test result after the object to be tested is tested with the teaching test item is more accurate.

In the embodiments provided by the present disclosure, it should be understood that the system and the method disclosed may be realized in other manners. The system embodiment described in the above is merely schematic, for example, the units are merely divided according to logical functions, but they may be divided in other manners in practical implementation, for another example, multiple units or components may be combined or may be integrated into another system, or some features may be omitted, or not executed. In addition, mutual couplings or direct couplings or communicative connections as shown or discussed may be indirect couplings or communicative connections via some communication interfaces, systems or units, and may be in an electrical form, a mechanical form or other forms.

The units described as separate parts may be or also may not be physically separated, the parts displayed as units may be or also may not be physical units, i.e., they may be located at one place, or also may be distributed on a plurality of network units. The object of the solution of the present embodiment may be realized by selecting part or all of the units thereof as actually required.

Besides, various functional units in the embodiments provided by the present disclosure may be integrated into one processing unit, or each unit also may exist in a physically independent manner, and two or more than two units also may be integrated into one unit.

If the function is realized in a form of software functional unit and is sold or used as an independent product, it may be stored in a computer readable storage medium. Based on such understanding, the technical solutions in essence or parts making contribution to the prior art or parts of the technical solutions of the present disclosure can be embodied in form of a software product, and this computer software product is stored in a storage medium, including several instructions for making one computer device (which can be a personal computer, a server or a network device etc.) execute all or part of the steps of the methods described in various examples of the present disclosure. The aforementioned storage medium includes various media in which program codes can be stored, such as U disk, mobile hard disk, Read-Only Memory (ROM), Random Access Memory (RAM), diskette and compact disk.

It should be noted that similar reference signs and letters represent similar items in the following accompanying drawings, therefore, once a certain item is defined in one accompanying drawing, it is not needed to be further defined or explained in subsequent accompanying drawings. Besides, terms such as “first”, “second”, and “third” are merely used for distinctive description, but should not be construed as indicating or implying relative importance.

Finally, it should be indicated that the embodiments described above are merely specific embodiments of the present disclosure, for illustrating the technical solutions of the present disclosure, rather than limiting the present disclosure. The scope of protection of the present disclosure should not be limited thereto. While the detailed description is made to the present disclosure with reference to the above-mentioned embodiments, those ordinarily skilled in the art should understand that the technical solutions recited in the above-mentioned embodiments still can be modified or readily changed, or equivalent substitutions can be made to some of the technical features therein, within the technical scope disclosed in the present disclosure, by any technician familiar with the present technical field; these modifications, changes, or substitutions do not make the essence of the corresponding technical solutions depart from the spirit and scope of the technical solutions of the embodiments of the present disclosure. They all should be covered within the scope of protection of the present disclosure. Therefore, the scope of protection of the present disclosure should be based on the scope of protection of the claims.

1. A method for matching a teaching test item, wherein the method comprises:
acquiring basic information of an object to be tested, to obtain a test category of the object to be tested;
judging whether a test result of a current teaching test item in a current test category satisfies a set requirement of the current teaching test item, wherein if the test result of the current teaching test item in the current test category fails to satisfy the set requirement, a matched teaching test item matched with the object to be tested is generated for the object to be tested;
acquiring a test result after a test is performed using the matched teaching test item, taking the matched teaching test item as a current teaching test item, and executing the step of judging whether the test result of the current teaching test item in a current test category satisfies a set requirement of the current teaching test item; and
outputting each generated teaching test item.

2. The method according to claim 1, wherein the method further comprises:
performing tests for teaching test items in a next test category, if the test result of the current teaching test item in the current test category satisfies the set requirement of the current teaching test item, until tests for all of the test categories are completed.

3. The method according to claim 1, wherein the step that the matched teaching test item matched with the object to be tested is generated for the object to be tested comprises:
selecting, from a preset teaching test item determination table, a teaching test item which is of a level lower than that of the current teaching test item and satisfies a test scene requirement corresponding to the current test category of the object to be tested, and taking a selected teaching test item as the matched teaching test item.

4. The method according to claim 3, wherein the step of selecting, from the preset teaching test item determination table, the teaching test item which is of level lower than that of the current teaching test item and satisfies the test scene requirement corresponding to the current test category of the object to be tested, and taking the selected teaching test item as the matched teaching test item, further comprises:
judging whether a number of the teaching test items each failing to satisfy respective set requirement is greater than a set threshold value, wherein
if the number of the teaching test items each failing to satisfy respective set requirement is greater than the set threshold value, the teaching test item of the level lower than that of the current teaching test item and satisfying the test scene requirement corresponding to the current test category of the object to be tested is selected from the preset teaching test item determination table, and the selected teaching test item is taken as the matched teaching test item.

5. The method according to claim 1, wherein the method further comprises:
selecting a teaching test item of a level higher than that of the test category and satisfying a test scene requirement corresponding to a next test category of the object to be tested for each test category in all of the test categories from the preset teaching test item determination table, if each test result corresponding to each of the teaching test items in all of the test categories satisfies the set requirement.

6. The method according to claim 3, wherein the teaching test item determination table is constructed in a following manner:
acquiring historical data;
determining, from the historical data, multiple test categories and at least one keyword corresponding to each test category;
determining a teaching test item corresponding to each of the keywords; and
generating the teaching test item determination table including correspondence relationships between test category levels and the teaching test items corresponding to the test categories.

7. The method according to claim 6, wherein the teaching test item determination table at least comprises a teaching test element table, and the teaching test element table is constructed in a following manner:
extracting basic information corresponding to the teaching test items from the historical data;
determining at least one corresponding teaching test element for each teaching test item; and
forming the teaching test element table including correspondence relationships among the basic information, the teaching test items, and the teaching test elements.

8. The method according to claim 6, wherein the teaching test item determination table at least comprises a test capability level determination table, and the test capability determination table is constructed in a following manner:
determining at least one corresponding test category level for each test category; and
forming the test capability level determination table including correspondence relationships between the test categories and the test category levels.

9. The method according to claim 1, wherein the basic information at least comprises sex, age, region, race, nationality, blood type, activity scene, and personality.

10. An apparatus for matching a teaching test item, wherein the apparatus comprises:
a first processing module, configured to acquire basic information of an object to be tested, to obtain a test category of the object to be tested;
a second processing module, configured to judge whether a test result of a current teaching test item in a current test category satisfies a set requirement of the current teaching test item, wherein if the test result of the current teaching test item in the current test category fails to satisfy the set requirement, a matched teaching test item matched with the object to be tested is generated for the object to be tested;
a third processing module, configured to acquire a test result after a test is performed using the matched teaching test item, and take the matched teaching test item as a current teaching test item, to execute the step of judging whether the test result of the current teaching test item in a current test category satisfies a set requirement of the current teaching test item; and
an output module, configured to output each teaching test item generated by the second processing module.

11. The apparatus according to claim 10, wherein the apparatus further comprises a fourth processing module, the fourth processing module is configured to:
perform a test for a teaching test item in a next test category, if the test result of the current teaching test item in the current test category satisfies the set requirement of the current teaching test item, until tests for all of the test categories are completed.

12. The apparatus according to claim 10, wherein the second processing module is configured to:
select a teaching test item of a level lower than that of the current teaching test item and satisfying a test scene requirement corresponding to the current test category of the object to be tested from a preset teaching test item determination table, and take a selected teaching test item as the matched teaching test item.

13. The apparatus according to claim 10, wherein the third processing module is further configured to:
judge whether a number of the teaching test items each failing to satisfy respective set requirement is greater than a set threshold value, wherein
if the number of the teaching test items each failing to satisfy respective set requirement is greater than the set threshold value, the teaching test item of the level lower than that of the current teaching test item and satisfying the test scene requirement corresponding to the current test category of the object to be tested is selected from the preset teaching test item determination table, and the selected teaching test item is taken as the matched teaching test item.

14. The apparatus according to claim 10, wherein the apparatus further comprises a fifth processing module, the fifth processing module is configured to:
select a teaching test item of a level higher than that of the test category and satisfying a test scene requirement corresponding to each next test category of the object to be tested for each test category in all of the test categories from the preset teaching test item determination table, if each test result corresponding to each of the teaching test items in all of the test categories satisfies the set requirement.

15. The apparatus according to claim 10, wherein the apparatus further comprises a constructing module, the constructing module constructs the teaching test item determination table in a following manner:
acquiring historical data;
determining, from the historical data, multiple test categories and at least one keyword corresponding to each test category;
determining a teaching test item corresponding to each of the keywords; and
generating the teaching test item determination table including correspondence relationships between test category levels and the teaching test items corresponding to the test categories.

16. The apparatus according to claim 15, wherein the teaching test item determination table at least comprises a teaching test element table, and the constructing module constructs the teaching test element table in a following manner:
extracting basic information corresponding to the teaching test items from the historical data;
determining at least one corresponding teaching test element for each teaching test item; and
forming the teaching test element table including correspondence relationships among the basic information, the teaching test items, and the teaching test elements.

17. The apparatus according to claim 15, wherein the teaching test item determination table at least comprises a test capability level determination table, and the constructing module constructs the test capability determination table in a following manner:
determining at least one corresponding test category level for each test category; and
forming the test capability level determination table including correspondence relationships between the test categories and the test category levels.

18. The apparatus according to claim 10, wherein the basic information at least comprises sex, age, region, race, nationality, blood type, activity scene, and personality.

19. A computer device, comprising a storage, a processor, and a computer program stored on the storage and executable on the processor, wherein the processor realizes steps in the method according to claim 1 when executing the computer program.

20. The computer device according to claim 19, wherein the teaching test item determination table is constructed in a following manner:
acquiring historical data;
determining, from the historical data, multiple test categories and at least one keyword corresponding to each test category;
determining a teaching test item corresponding to each of the keywords; and
generating the teaching test item determination table including correspondence relationships between test category levels and the teaching test items corresponding to the test categories.
